(19) United States
(12) Patent Application Publication
(10) Pub. No.: US 2014/0281148 A1
(43) Pub. Date: Sep. 18, 2014

(54) MEMORY SYSTEM

(71) Applicant: KABUSHIKI KAISHA TOSHIBA, Minato-ku (JP)

(72) Inventors: Makoto Ichida, Yokohama-shi (JP); Norikazu Yoshida, Kawasaki-shi (JP); Toshikatsu Hida, Yokohama-shi (JP)

(73) Assignee: KABUSHIKI KAISHA TOSHIBA, Minato-ku (JP)

(21) Appl. No.: 13/904,191

(22) Filed: May 29, 2013

Related U.S. Application Data
(60) Provisional application No. 61/790,347, filed on Mar. 15, 2013.

(51) Int. Cl. G06F 12/02

(52) U.S. Cl. CPC G06F 12/0246
USPC 711/103

(57) ABSTRACT

According to one embodiment, a memory system comprises a nonvolatile memory, a first volatile memory which stores management information to manage the nonvolatile memory, a controller which controls operations of the nonvolatile memory and the first volatile memory, and a power supply circuit which makes power supplied to part of the first volatile memory zero in accordance with a data capacity of the management information in response to a request from the controller.

### CROSS-REFERENCE TO RELATED APPLICATIONS

This application claims the benefit of U.S. Provisional Application No. 61/790,347, filed Mar. 15, 2013, the entire contents of which are incorporated herein by reference.

### FIELD

Embodiments described herein relate generally to a memory system.

### BACKGROUND

In recent years, development of a solid-state drive (SSD) as a data storage device using a NAND flash memory (to also be simply referred to as a flash memory hereinafter) that is a rewritable nonvolatile (or non-transitory) memory is being pushed forward.

An SSD includes a flash memory and a volatile memory that stores address management information for managing addresses of the flash memory. The data capacity stored in the volatile memory (amount of address management information) is proportionate to the storage capacity of the flash memory (number of physical addresses). Thus, the data capacity stored in the volatile memory is decreased when the storage capacity of the flash memory is small.

However, even though the data capacity stored in a volatile memory is small and the volatile memory is not partly used, power is supplied to all of the volatile memory, resulting in an undesired power supply. This causes a problem that power cannot be lowered.

### BRIEF DESCRIPTION OF THE DRAWINGS

FIG. 1 is a block diagram showing an example of a configuration of a memory system according to a first embodiment;

FIG. 2 is a block diagram showing an example of a configuration of a memory controller according to the first embodiment;

FIG. 3 is a flowchart showing an example of an operation of a memory system according to the first embodiment;

FIGS. 4, 5, and 6 is a block diagram illustrating an example of an operation of the memory system according to the first embodiment;

FIG. 7 is a block diagram illustrating an example of an operation of a memory system according to a comparative example;

FIG. 8 is a flowchart showing an example of an operation of a memory system according to a second embodiment;

FIG. 9 is a block diagram illustrating an example of an operation of the memory system according to the second embodiment;

FIG. 10 is a block diagram showing an example of a configuration of a DRAM related to a third embodiment;

FIG. 11 is a table showing an example of PASR setting information in a setting register related to the third embodiment;

FIG. 12 is a schematic block diagram showing a configuration of a DRAM for performing PASR control as shown in FIG. 11;

FIG. 13 is a chart showing an example of self refresh related to the third embodiment;

FIG. 14 is a flowchart showing an example of an operation of a memory system according to the third embodiment;

FIG. 15 is a block diagram illustrating an example of an operation of the memory system according to the third embodiment;

FIG. 16 is a perspective view showing an application example of a personal computer including an SSD according to each of the first to third embodiments;

FIG. 17 is a block diagram showing an application example of a personal computer including an SSD according to each of the first to third embodiments;

FIG. 18 is a block diagram showing an example of application of an SSD according to each of the first to third embodiments to a device sleep operation; and

FIG. 19 is a conceptual diagram showing an application example of a server including an SSD according to each of the first to third embodiments.

### DETAILED DESCRIPTION

In general, according to one embodiment, a memory system comprises: a NAND flash memory; a first volatile memory which stores address management information for making a logical address assigned for a host and a physical address of the NAND flash memory correspondent with each other; a controller which includes a second volatile memory and sends an operation request to the NAND flash memory and the first volatile memory to control the NAND flash memory and the first volatile memory; and a power supply circuit electrically connected to the host through a power supply connector to receive power from the host through the power supply connector, the power supply circuit decreasing power, which is supplied to part of the first volatile memory in accordance with a data capacity of the address management information stored in firmware in the controller in response to the operation request from the controller, to zero, and the power supply circuit decreasing power, which is supplied to the second volatile memory, to zero.

Embodiments will be described below with reference to the accompanying drawings. In the drawings, the units having the same function are denoted by the same reference numeral. Some overlapping descriptions may be given when the need arises.

### First Embodiment

A memory system according to a first embodiment will be described with reference to FIGS. 1 to 7. The first embodiment is directed to an example in which when address management information of a nonvolatile memory (NAND flash memory) 24 is stored in a volatile memory (static random access memory (SRAM)) 25j in a memory controller 25, the supply of power to an unused area of the SRAM 25j is shut off. This can decrease power consumption in the memory system. Hereinafter, the first embodiment will be described in detail.

[Example of Configuration of Memory System]

An example of a configuration of the memory system according to the first embodiment will be described.

FIG. 1 is a block diagram showing an example of a configuration of a memory system 20 according to the first embodiment. In this embodiment, the memory system 20 is SSD including a nonvolatile memory serving as an external storage device for use in a computer system. The following is an example in which the NAND flash memory 24 is used as a nonvolatile memory.

As shown in FIG. 1, the memory system 20 is connected to a host 10 (information processing device) through a host interface 25a. The host 10 is an external device which writes data to a storage device including a NAND flash memory 24 and reads data out of the storage device. The host 10 is configured by, for example, a personal computer, a CPU core and a server connected to a network alone or in combination. The host 10 controls power supplied to each module including the memory system 20. The host 10 also controls data access to the memory system 20 and sends a write request, a read request and an erase request to, for example, the memory system 20 to write data to the memory system 20, read data therefrom and erase data therefrom.

The memory system 20 includes a power supply connector 21, a power supply circuit 22, a dynamic random access memory (DRAM) (volatile memory) 23, a NAND flash memory (nonvolatile memory) 24 and a memory controller 25. The power supply circuit 22 can partly be included in the memory controller 25 for the purpose of stopping a power supply to an SRAM, for example.

The memory controller 25 is connected to the host 10 through the host interface 25a. The host interface 25a is a device such as serial advanced technology attachment (SATA), peripheral component interconnect express (PCIe), serial attached SCSI (SAS) and universal serial bus (USB). In the first embodiment, for example, SATA is used as the host interface 25a. The memory controller 25 performs the main control of the memory system 20. Details of the memory controller 25 will be discussed later.

The DRAM (volatile memory) 23 is connected to the memory controller 25 through a DRAM interface 25b. The DRAM 23 is used as a storage unit for data transfer (data transfer buffer). More specifically, the DRAM 23 temporally stores write data sent from the host 10 before the write data is written to the NAND flash memory 24 and also temporally stores read data read out of the NAND flash memory 24 before the read data is sent to the host 10.

The NAND flash memory 24 is connected to the memory controller 25 through a NAND interface 25c. The NAND flash memory 24 stores user data managed by the host 10 and also stores management information managed by the DRAM 23 for backup. The NAND flash memory 24 includes, for example, a plurality of NAND memory chips 24a (eight NAND memory chips 24a in the first embodiment).

Each of the NAND memory chips 24a includes a memory cell array in which a plurality of memory cells are arranged in matrix, and the memory cell array includes a plurality of arrays of physical blocks each of which is a unit of data erasure. Each of the physical blocks includes a plurality of physical pages. Data is written to and read from the NAND flash memory 24 for each of the physical pages. The NAND memory chips 24a are connected to the NAND interface 25c and separated into a plurality of parallel operation elements (channels Ch0 to Ch3) which perform a parallel operation. In the first embodiment, the eight NAND memory chips 24a are separated by two into four channels Ch0 to Ch3.

The storage capacity of each of the NAND memory chips 24a is, for example, 4 GB and that of the entire NAND flash memory 24 is, for example, 32 GB.

The power supply connector 21 is electrically connected to the host 10 to receive different types of power (electrical signals of different voltage levels) for the memory system 20 from the host 10. The power supply circuit 22 is electrically connected to the power supply connector 21 and also to the DRAM 23, NAND flash memory 24 and memory controller 25. The power supply circuit 22 receives different types of power from the power supply connector 21 and supplies the different types of power to the DRAM 2, NAND flash memory 24 and memory controller 25.

[Example of Configuration of Memory Controller]

An example of a configuration of the memory controller according to the first embodiment will be described below.

FIG. 2 is a block diagram showing an example of a configuration of the memory controller 25 according to the first embodiment.

As shown in FIG. 2, the memory controller 25 includes a CPU 25d, a ROM 25e, a protocol control circuit 25f, an encryption control circuit 25g, an ECC control circuit 25h, a data buffer 25i and an SRAM 25j that is configured by a flip-flop circuit.

The CPU 25d performs the main control of the entire memory system 20. Firmware is invoked from the firmware (system start-up program) stored in advance in the ROM 25e and added for use as a program for controlling the CPU 25d.

The protocol control circuit 25f controls the protocol of the memory system 20 in accordance with the protocol of the host to receive write data from the host interface 25a. The encryption control circuit 25g encrypts the write data received by the protocol control circuit 25f and then temporarily stores the encrypted write data in the DRAM 23, which is provided outside the memory controller 25, through the DRAM interface 25e. The ECC control circuit 25h adds error correcting information to the write data. The data buffer 25i temporarily stores the write data to which the error correcting information is added, and stores the write data in the NAND flash memory 24, which is also provided outside the memory controller 25, through the NAND interface 25c.

The SRAM 25j stores management information for managing the NAND flash memory 24. The management information is address management information for managing a logical address designated by the host 10 and a physical address of the NAND flash memory 24, which corresponds to the logical address. In other words, the management information is, for example, a logical address/physical address conversion table (look up table (LUT)).

The storage capacity of the SRAM 25j is, for example, 128 KB. This 128 KB storage capacity of the SRAM 25j is necessary for the data amount of address management information of the NAND flash memory 24 when the storage capacity of the NAND flash memory 24 is 64 GB. In other words, when the storage capacity of the NAND flash memory 24 is 64 GB, the data amount of address management information of the NAND flash memory 24 is 128 KB. The storage capacity of the NAND flash memory 24 and the data amount of address management information thereof are proportionate to each other. The storage capacity of the SRAM 25j is, for example, 128 KB, and the SRAM 25j need not be configured as one unit but can be divided into a plurality of SRAMs. For securing the 128 KB storage capacity, for example, four SRAMs each having a storage capacity of 32 KB can be employed.

If the storage capacity of the NAND flash memory 24 is 32 GB, the data capacity of address management information of the NAND flash memory 24 is 64 KB. Thus, if the storage capacity of the NAND flash memory 24 is 32 GB and the storage capacity of the SRAM 25j is 128 KB, about half of the SRAM 25j is used as a storage area for address management information of the NAND flash memory 24. In other words, the remaining about half of the SRAM 25j is not used as a storage area.

[Example of Operation]

An example of an operation of the memory system 20 according to the first embodiment will be described below.

FIG. 3 is a flowchart showing an example of an operation of the memory system 20 according to the first embodiment. FIG. 4 is a block diagram illustrating an example of an operation of the memory system 20 according to the first embodiment. In this memory system 20, the NAND flash memory 24 includes eight NAND memory chips 24a and thus has a storage capacity of 32 GB, for example. The storage capacity (128 KB) of the SRAM 25j is larger than the data capacity (64 KB) of address management information of the NAND flash memory 24.

The operation of the memory system 20 includes a data write operation, a data read operation and a data erase operation in normal mode; however, it is not limited to these operations but can be an operation in power-saving mode, or standby mode (sleep mode). These operations can be applied to all operations for allowing power to be supplied to the memory system 20.

The normal mode is a mode in which power is supplied to each unit sufficiently such that the unit can perform a data write operation, a data read operation, a data erase operation and so on. The standby mode saves power more than the normal mode and it is a mode in which a power supply to each unit is shut off and a power supply voltage of each unit is lower than usual.

Referring to FIGS. 3 and 4, in step S10, the power supply circuit 22 supplies a power supply voltage (power) to each of the units (DRAM 23, NAND flash memory 24 and memory controller 25).

In step S11, the memory controller 25 sends a power supply control request to the power supply circuit 22. More specifically, the CPU 25d in the memory controller 25 sends a power supply control request to the power supply circuit 22 in accordance with the firmware stored in the ROM 25e. This power supply control request is a request for shutting off power to part of the SRAM 25j and a program stored in the firmware in advance on the basis of the storage capacity (32 GB in this embodiment) of the NAND flash memory 24. In other words, the power supply control request is a program stored in the firmware in advance on the basis of the data capacity of address management information of the NAND flash memory 24, which is proportionate to the storage capacity of the NAND flash memory 24. Shutting off the supply of power means decreasing power to be supplied from a power supply to zero or almost zero (virtually zero).

In step S12, the power supply circuit 22 shuts off power to part of the SRAM 25j in response to the power supply control request from the memory controller 25. This part of the SRAM 25j is an area that is not used as a storage area for address management information of the NAND flash memory 24.

As discussed above, the 128 KB storage capacity of the SRAM 25j is necessary for the data capacity of address management information of the NAND flash memory 24 when the storage capacity of the NAND flash memory 24 is 64 GB. In FIG. 4, the storage capacity of the SRAM 25j is, for example, 128 KB and the storage capacity of the NAND flash memory 24 (eight NAND memory chips 24a) is, for example, 32 GB. Since, therefore, the data capacity of address management information of the NAND flash memory 24 is 64 KB, about half of the SRAM 25j is used as a storage area for address management information of the NAND flash memory 24. In other words, the remaining half of the SRAM 25j is not used as a storage area. More specifically, power is supplied to about half of the SRAM 25j, which is used as a storage area of the SRAM 25j, whereas a power supply to about half of the SRAM 25j is shut off, which is not used as a storage area of the SRAM 25j.

FIG. 5 is a block diagram illustrating an example of an operation of the memory system 20 according to the first embodiment. In this memory system 20, the NAND flash memory 24 includes four NAND memory chips 24a and thus has a storage capacity of 16 GB, for example. The storage capacity (128 KB) of the SRAM 25j is larger than the data capacity (32 KB) of address management information of the NAND flash memory 24.

In FIG. 5, the storage capacity of the SRAM 25j is, for example, 128 KB and the storage capacity of the NAND flash memory 24 (four NAND memory chips 24a) is, for example, 16 GB. Since, therefore, the data capacity of address management information of the NAND flash memory 24 is 32 KB, about one-quarter the SRAM 25j is used as a storage area for address management information of the NAND flash memory 24. In other words, the remaining about three-fourths the SRAM 25j is not used as a storage area. More specifically, power is supplied to about one-quarter the SRAM 25j, which is used as a storage area of the SRAM 25j, whereas a power supply to about three-fourths the area of the SRAM 25j, which is not used as a storage area of the SRAM 25j, is shut off.

FIG. 6 is a block diagram illustrating an example of an operation of the memory system 20 according to the first embodiment. In this memory system 20, the NAND flash memory 24 includes sixteen NAND memory chips 24a and thus has a storage capacity of 64 GB, for example. The storage capacity (128 KB) of the SRAM 25j is almost the same as the data capacity (128 KB) of address management information of the NAND flash memory 24.

In FIG. 6, the storage capacity of the SRAM 25j is, for example, 128 KB and the storage capacity of the NAND flash memory 24 (sixteen NAND memory chips 24a) is, for example, 64 GB. Since, therefore, the data capacity of address management information of the NAND flash memory 24 is 128 KB, all of the SRAM 25j is used as a storage area for address management information of the NAND flash memory 24. In other words, power is supply to all of the SRAM 25j which is used as a storage area of the SRAM 25j.

As described above, in the first embodiment, power consumption can be decreased by shutting off a power supply to that part of the SRAM 25j which is not used as a storage area for address management information of the NAND flash memory 24.

### Advantages of First Embodiment

In the above-described first embodiment, when address management information of the NAND flash memory 24 is stored in the SRAM 25j in the memory controller 25, a power supply to the SRAM 25j is controlled. The following advantages can thus be produced.

FIG. 7 is a block diagram illustrating an example of an operation of a memory system 20 according to a comparative example. In this memory system 20, the NAND flash memory 24 includes eight NAND memory chips 24a. The configuration of the memory system 20 according to the comparative example is similar to that of the memory system 20 according to the first embodiment as shown in FIG. 4.

In the comparative example of FIG. 7, the storage capacity of the SRAM 25j is, for example, 128 KB and the storage capacity of the NAND flash memory 24 (eight NAND memory chips 24a) is, for example, 32 GB. Since, therefore, the data capacity of address management information of the NAND flash memory 24 is 64 KB, about half of the SRAM 25j is used as a storage area for address management information of the NAND flash memory 24. In other words, the remaining about half of the SRAM 25j is not used as a storage area. In the comparative example, however, power is supplied to all of the SRAM 25j, or that part of the SRAM 25j which is used as a storage area and that part thereof which is not used as a storage area. Thus, undesired power is supplied to that part of the SRAM 25j which is not used as a storage area.

In contrast to the comparative example, in the first embodiment, power is supplied to that part of the SRAM 25j which is used as a storage area and a power supply to that part of the SRAM 25j which is not used as a storage area is shut off. If the storage capacity of the SRAM 25j is larger than the data capacity of address management information of the NAND flash memory 24, an undesired power supply to that part of the SRAM 25j which is not used is shut off. Thus, the memory system 20 can be decreased in power consumption.

In the first embodiment, the storage capacity of the SRAM 25j remains unchanged, irrespective of the storage capacity of the NAND flash memory 24. In other words, the memory system 20 is provided with the memory controller 25 having the same configuration as that of the NAND flash memory 24, irrespective of the storage capacity of the NAND flash memory 24. Therefore, an additional memory controller need not be manufactured, which prevents manufacturing costs from increasing.

### Second Embodiment

A memory system according to a second embodiment will be described with reference to FIGS. 8 and 9. The second embodiment is directed to an example in which when address management information of a NAND flash memory 24 is stored in a volatile memory (DRAM) 23 provided outside a memory controller 25, a power supply to all of an SRAM 25j and part of the DRAM 23 which is not used as a storage area are shut off. This can decrease power consumption in the memory system. Hereinafter, the second embodiment will be described in detail only with respect to its elements different chiefly from those of the first embodiment.

[Example of Operation]

An example of an operation of a memory system 20 according to the second embodiment will be described below.

FIG. 8 is a flowchart showing an example of an operation of the memory system 20 according to the first embodiment. FIG. 9 is a block diagram illustrating an example of an operation of the memory system 20 according to the second embodiment. In this memory system 20, the NAND flash memory 24 includes NAND memory chips 24a the number of which is larger than sixteen.

Thus, the NAND flash memory 24 has a storage capacity of larger than 64 GB, for example (e.g., 512 GB). The storage capacity (128 KB) of the SRAM 25j is smaller than the data capacity (1024 KB) of address management information of the NAND flash memory 24. Hence, the address management information of the NAND flash memory 24 cannot be stored in the SRAM 25j.

As shown in FIG. 9, in the second embodiment, the DRAM 23 includes not only a first storage area 23f-1 included in a memory cell array 23f and serving as a data buffer for data transfer but also a second storage area 23f-2 for storing address management information of the NAND flash memory 24. The storage capacity of the second storage area 23f-2 is, for example, 2048 KB, and is larger than the data capacity (1024 KB) of address management information of the NAND flash memory 24.

The example of an operation of the memory system 20 includes a data write operation, a data read operation and a data erase operation in normal mode; however, it is not limited to these operations but can be an operation in power-saving mode, or standby mode (sleep mode). These operations can be applied to all operations for allowing power to be supplied to the memory system 20.

Referring to FIGS. 8 and 9, in step S20, a power supply circuit 22 supplies power to each of the units (DRAM 23, NAND flash memory 24 and memory controller 25).

In step S21, the memory controller 25 sends a power supply control request to the power supply circuit 22. More specifically, a CPU 25d in the memory controller 25 sends a power supply control request to the power supply circuit 22 in accordance with the firmware stored in a ROM 25e. This power supply control request is a request for shutting off a power supply to all of the SRAM 25j and a request for shutting off a power supply to part of the second storage area 23f-2. The power supply control request is also a program stored in the firmware in advance on the basis of the storage capacity (512 GB in this embodiment) of the NAND flash memory 24. In other words, the power supply control request is a program stored in the firmware in advance on the basis of the data capacity of address management information of the NAND flash memory 24, which is proportionate to the storage capacity of the NAND flash memory 24.

In step S22, the power supply circuit 22 shuts off a power supply to all of the SRAM 25j in response to the power supply control request from the memory controller 25. All of the SRAM 25j is an area that is not used as a storage area for address management information of the NAND flash memory 24.

The power supply circuit 22 also shuts off a power supply to part of the second storage area 23f-2 in the DRAM 23 in response to the power supply control request from the memory controller 25. This part of the second storage area 23f-2 is an area that is not used as a storage area for address management information of the NAND flash memory 24.

As discussed above, the 2048 KB storage capacity of the second storage area 23f-2 is necessary for the data capacity of address management information of the NAND flash memory 24 when the storage capacity of the NAND flash memory 24 is 1024 GB. In FIG. 9, the storage capacity of the second storage area 23f-2 is, for example, 2048 KB and the storage capacity of the NAND flash memory 24 is, for example, 512 GB. Since, therefore, the data capacity of address management information of the NAND flash memory 24 is 1024 KB, about half of the second storage area 23f-2 is used as a storage area for address management information of the NAND flash memory 24. In other words, the remaining about half of the second storage area 23f-2 is not used as a storage area. More specifically, power is supplied to about half of the second storage area 23f-2, which is used as a storage area of the second storage area 23f-2, whereas a power supply to about half of the second storage area 23f-2 is shut off, which is not used as a storage area of the second storage area 23f-2, or a power supply to about half of the second storage area 23f-2 is shut off or suppressed.

### Advantages of Second Embodiment

In the above-described second embodiment, when address management information of the NAND flash memory 24 is stored in the DRAM 23 (second storage area 23f-2) provided outside the memory controller 25, a power supply to the second storage area 23f-2 is controlled. More specifically, power is supplied to that part of the second storage area 23f-2 which is used as a storage area and a power supply to that part of the second storage area 23f-2 which is not used as a storage area is shut off. If the storage capacity of the second storage area 23f-2 is larger than the data capacity of address management information of the NAND flash memory 24, an undesired power supply to that part of the second storage area 23f-2 which is not used is shut off. Therefore, the memory system 20 can be decreased in power consumption.

According to the second embodiment, a power supply to the SRAM 25j in the memory controller 25 is controlled. In other words, a power supply to all of the SRAM 25j which is not used as a storage area is shut off. Thus, the memory system 20 can be decreased further in power consumption.

### Third Embodiment

A memory system according to a third embodiment will be described with reference to FIGS. 10 and 15. The third embodiment is directed to an example in which when address management information of a NAND flash memory 24 is stored in a DRAM 23 outside a memory controller 25 as in the second embodiment, no self refresh is performed for that part of the DRAM 23 which is not used as a storage area (an area in which data need not be held). This can decrease power consumption in the memory system. Hereinafter, the third embodiment will be described only with respect to its elements different chiefly from those of the above first and second embodiments.

[Example of Configuration of DRAM and Example of Operation of Partial Array Self Refresh]

An example of a configuration of the DRAM 23 related to the third embodiment and an example of an operation of partial array self refresh related thereto will be described below.

The memory cells of a DRAM each include a transistor and a capacitor and store data by storing charges in the capacitor. The charges decrease as time passes, thereby causing a data error. Self refresh is to resupply (refresh) charges periodically and automatically in a DRAM, and partial array self refresh (PASR) is to perform self array refresh for that part of a memory cell array which is necessary for data retention in a DRAM. Hereinafter, an example of the configuration of the DRAM and an example of the operation of partial array self refresh thereof will be described in detail.

FIG. 10 is a block diagram showing an example of the configuration of the DRAM 23 related to the third embodiment.

As shown in FIG. 10, the DRAM 23 includes a setting register 23a, a command decoder 23b, a self refresh controller 23c, a PASR state controller 23d, a bank activation controller 23e and a memory cell array 23f (first storage area 23f-1 and second storage area 23f-2).

The memory cell array 23f is divided into, for example, four banks 0 to 3 which can perform a parallel operation, and these banks have the same configuration. Each of the banks includes a plurality of memory cells that are arranged at the nodes of a plurality of word lines and a plurality of bit lines. To gain access to the memory cell array 23f, a designated bank of the memory cell array can be accessed independently. Self refresh can be performed for each of the banks. With respect to the self refresh, partial array self refresh (PASR) can be controlled for a predetermined area of the four banks 0 to 3.

In response to an input external command, the command decoder 23b generates its corresponding internal command or control signal and sends it to each of the units (setting register 23a, self refresh controller 23c, PASR state controller 23d and memory cell array 23f).

When a given setting command is input to the command decoder 23b, information necessary for setting various operation modes of the DRAM 23 is written to the setting register 23a.

The self refresh controller 23c controls self refresh in the DRAM 23 to generate row addresses of word lines to be refreshed at regular time intervals.

The PASR state controller 23d retains PASR setting information. The PASR state controller 23d determines whether the banks are to be refreshed on the basis of the row addresses generated by the self refresh controller 23c and selects a bank to be refreshed.

The bank activation controller 23e supplies bank active signals A0 to A3 to the banks 0 to 3, respectively in accordance with the selection control of the PASR state controller 23d.

The configurations and operations of the setting register 23a, self refresh controller 23c, PASR state controller 23d and bank activation controller 23e will be described in detail below.

FIG. 11 is a table showing an example of PASR setting information in the setting register 23a related to the third embodiment.

As shown in FIG. 11, PASR setting information is written to part (corresponding to the lower three bits in FIG. 11) of the setting register 23a by inputting a given setting command, for example. Since the DRAM 23 includes four banks 0 to 3, the number of banks to be refreshed to retain data, can be selected from the three options of all banks, two banks (e.g., bank 0 and bank 1) and one bank (e.g., bank 0) on the basis of the PASR setting information. The selection of a bank is performed on the basis of two-bit bank selection addresses BA0 and BA1, as shown in FIG. 9.

FIG. 12 is a schematic block diagram showing a configuration of the DRAM 23 for performing PASR control as shown in FIG. 11. In FIG. 12, of all the units of the DRAM 23, the self refresh controller 23c, PASR state controller 23d and bank activation controller 23e are shown.

As shown in FIG. 12, when self refresh enters/exits, a PASR Entry/exit signal is supplied to the self refresh controller 23c, PASR state controller 23d and bank activation controller 23e. As the PASR setting information shown in FIG. 11, control signals corresponding to two options (two banks/one bank) of banks to be refreshed are supplied to the PASR state controller 23d.

When self refresh enters, the refresh counter 23c-2 sequentially counts up and outputs the row addresses in synchronization with the internal clocks generated at regular time intervals from a self refresh oscillator 23c-1 of the self refresh controller 23c. In the PASR state controller 23d, in accordance with the setting information shown in FIG. 11, a register R10 is set at a high level when two banks are set, and a register R11 is set at a high level when one bank is set. The PASR state controller 23d includes two AND gates A10 and A11. The output of the register R10 is connected to one end of the AND gate A10 and that of the register R11 is connected to one end of the AND gate A11, and a PASR Entry/Exit signal is supplied to the other ends of the AND gates A10 and A11, with the result that the AND gates A10 and A11 output bank stop signals SG1 and SG2, respectively.

In the bank activation controller 23e, one of four decode signals is selected and activated in normal operation mode in accordance with two-bit bank selection addresses BA0 and BA1 input to a bank selection decoder 23e-1. In response to the PASR Entry/Exit signal input to the bank selection decoder 23e-1, the four decode signals are all activated during the self refresh period. The four decode signals are input to bank active signal generators 23e-2 to 23e-5 of the banks 0 to 3, respectively. The bank stop signal SG1 is input to the bank active signal generators 23e-4 and 23e-5 of the banks 2 and 3, and the bank stop signal S20 is input to the bank active signal generators 23e-3 to 23e-5 of the banks 1 to 3.

When the bank stop signals SG1 and SG2 input to the bank active signal generators 23e-2 to 23e-5 are in an inactive state (at a low level) and the decode signals input thereto are in an active state (at a high level), the bank active signal generators 23e-2 to 23e-5 activate the bank active signals A0 to A3 supplied to their corresponding banks. Thus, only one bank active signal A0 is activated when self refresh is performed for one bank, and only two bank active signals A0 and A1 are activated when self refresh is performed for two banks. During the self refresh period, by the row addresses output from the refresh counter 23C-2 at regular time intervals, refresh is performed by activating only the selection word line of a bank to be refreshed, and refresh for a bank not to be refreshed is stopped.

FIG. 13 is a chart showing an example of self refresh performed when one bank (bank 0) is set as one to be refreshed.

As shown in FIG. 13, during the self refresh period, the self refresh oscillator 23c-1 outputs internal clocks at regular time intervals of t0 and the command decoder 23b outputs internal commands REF in synchronization with the internal clocks. At this time, a bank 0 to be refreshed is designated according to the setting information of the setting register 23a and thus only the bank active signal A0 is selected and activated in the configuration shown in FIG. 12. Therefore, the selection word line of the bank 0 is refreshed and none of the other banks 1 to 3 are refreshed. The same operation is repeated at regular time intervals of t0 and continues until the end of the self refresh period.

Since the above operation reduces the number of banks to be refreshed during the self refresh period, power consumption can be lowered by the reduction when the DRAM 23 is in standby mode.

In the third embodiment, the above-described PASR is applied to the second storage area 23f-2 of the DRAM 23 that stores the address management information of the NAND flash memory 24 which will be described later.

[Example of Operation]

An example of an operation of the memory system 20 according to the third embodiment will be described below.

FIG. 14 is a flowchart showing an example of an operation of the memory system 20 according to the third embodiment. FIG. 15 is a block diagram illustrating an example of an operation of the memory system 20 according to the third embodiment. In this memory system 20, the NAND flash memory 24 includes NAND memory chips 24a the number of which is larger than sixteen.

The memory system 20 according to the third embodiment has a configuration similar to that of the memory system according to the second embodiment. The operation of the memory system 20 according to the third embodiment is self refresh.

Referring to FIGS. 14 and 15, in step S30, a power supply circuit 22 supplies power to each of the units (DRAM 23, NAND flash memory 24 and memory controller 25).

In step S31, the memory controller 25 sends a self refresh power supply request to the power supply circuit 22. More specifically, a CPU 25d in the memory controller 25 sends a self refresh power supply request to the power supply circuit 22 in accordance with the firmware stored in a ROM 25e. This self refresh power supply request is a request for supplying self refresh power to part of the second storage area 23f-2 in the DRAM 23. The self refresh power is sufficient for performing self refresh and higher than the power supplied to the DRAM 23 in step S30. The self refresh power supply request is also a program stored in advance in the firmware on the basis of the storage capacity (512 GB in this embodiment) of the NAND flash memory 24. In other words, the self refresh power supply request is a program stored in the firmware in advance on the basis of the data capacity of address management information of the NAND flash memory 24, which is proportionate to the storage capacity of the NAND flash memory 24.

In step S32, the power supply circuit 22 supplies self refresh power to part of the second storage area 23f-2 in the DRAM 23 in response to the power supply control request from the memory controller 25. The part of the second storage area 23f-2 to which self refresh power is supplied, is an area that is used as a storage area for address management information of the NAND flash memory 24. In other words, the power supply circuit 22 does not supply self refresh power to the other part of the second storage area 23f-2 in the DRAM 23 but stops.

As discussed above, PASR is performed to refresh that part of the second storage area 23f-2 in the DRAM 23 which is used as a storage area for address management information.

### Advantages of Third Embodiment

In the above-described third embodiment, when address management information of the NAND flash memory 24 is stored in the DRAM 23 (second storage area 23f-2) provided outside the memory controller 25, a self refresh power supply to the second storage area 23f-2 is controlled. More specifically, self refresh power is supplied to that part of the second storage area 23f-2 which is used as a storage area. Self refresh (PASR) is performed only for that part of the second storage area 23f-2 in which data should be retained. Hence, the memory system 20 can be decreased in power consumption in the memory system 20.

<Application Example>

Referring to FIGS. 16 to 20, an application example of the memory system (SSD) 20 according to each of the first to third embodiments will be described below.

FIG. 16 is a perspective view showing an application example of a personal computer including the SSD 20 according to each of the embodiments.

As shown in FIG. 16, a personal computer 200 includes a main body 201 and a display unit 202.

The display unit 202 includes a display housing 203 and a display device 204 housed in the display housing 203. The main body 201 includes a housing 205, a keyboard 206 and a touch pad 207 serving as a pointing device.

The housing 205 includes a main circuit board, an optical disk device (ODD) unit, an SSD-dedicated card slot, a general-purpose card slot, an SSD 10 and so on.

The general-purpose card slot is provided adjacent to the peripheral wall of the housing 205. The peripheral wall includes an opening 208 opposed to the general-purpose card slot. A user can insert an additional device into a general-purpose card slot from outside the housing 205 through the opening 208 or pull it from the slot.

The SSD 20 can be used in place of a prior art hard disk drive (HDD) or can be used as an additional device that is inserted into the SSD-dedicated card slot in the housing 205 of the personal computer 200.

FIG. 17 is a block diagram showing an application example of the personal computer including the SSD 20 according to each of the embodiments.

The personal computer 200 includes a CPU 301, a north bridge 302, a main memory 303, a video controller 304, an audio controller 305, a south bridge 309, a BIOS-ROM 310, an SSD 10, an ODD unit 311, an embedded controller/keyboard controller IC (EC/KBC) 312, a network controller 313 and so on.

The CPU 301 is a processor designed to control the operations of the personal computer 200 and executes the operating system (OS) loaded into the main memory 303 from the SSD 10. When the ODD unit 311 can perform at least one of the read and write operations with respect to a loaded optical disk, the CPU 301 perform the operation.

The CPU 301 also executes the basic input system (BIOS) stored in the BIOS-ROM 310. The BIOS is a program for controlling the hardware in the personal computer 200.

The north bridge 302 is a bridge device connected between the local bus of the CPU 301 and the south bridge 309. The north bridge 302 includes a memory controller for controlling access to the main memory 303.

The north bridge 302 has functions of communicating with the video controller 304 via an accelerated graphics port (AGP) bus 314 and a peripheral component interconnect express (PCIe) bus and communicating with the audio controller 305.

The main memory 303 temporarily stores programs and data and serves as a work area of the CPU 301. The main memory 303 is configured by a RAM, for example.

The video controller 304 is a video playback controller for controlling the display unit 202 used as a display monitor of the personal computer 200.

The audio controller 305 is an audio playback controller for controlling a speaker 306 of the personal computer 200.

The south bridge 309 controls each of the devices on a low pin count (LPC) bus and each of the devices on a PCI bus 315. The south bridge 309 also controls the SSD 20, which is a storage device for storing various items of software and data, via an SATA interface.

The personal computer 200 gains access to the SSD 20 for each sector. The SSD 20 is supplied with, for example, a write command, a read command and a cache flash command via the ATA interface.

The south bridge 309 has a function of controlling access to the BIOS-ROM 310 and ODD unit 311.

The EC/KBC 312 is a one-chip microcomputer in which an embedded controller and a keyboard controller are integrated. The embedded controller manages power and the keyboard controller controls the keyboard (KB) 206 and touch pad 207.

The EC/KBC 312 has a function of turning on/off the power supply of the personal computer 200 according to a user's operation of the power button. The network controller 313 is a communication device for communicating with an external network such as the Internet.

FIG. 18 is a block diagram showing an example of application of the SSD 20 according to each of the embodiments to a device sleep operation.

As shown in FIG. 18, a power supply control circuit 26 is electrically connected to the host 10 and the power supply circuit 22. The power supply control circuit 26 sends an on/off power supply control request from the host 10 to the power supply circuit 22 in response to an on/off request. The power supply circuit 22 switches the mode of the DRAM 23, NAND flash memory 24 and memory controller 25 to a normal mode or a standby mode in response to the on/off power supply control request from the power supply control circuit 26.

Hereinafter, an example of a device sleep operation will be described.

In the normal mode, the power supply connector 21 supplies power to the power supply circuit 22, and the power supply circuit 22 supplies power to the DRAM 23, NAND flash memory 24 and memory controller 25. Thus, the DRAM 23, NAND flash memory 24 and memory controller 25 can perform a normal operation, and the SSD 20 performs an operation in response to a request (including a write request, a read request and an erase request) from the host 10.

When the normal mode transitions to the standby mode, the host 10 first sends an off request (standby mode transition request) to the power supply control circuit 26 of the SSD 20. In response to the off request, the power supply control circuit 26 sends an off power supply control request to the power supply circuit 22. In response to the off power supply control request, the power supply circuit 22 limits the power supply to the DRAM 23, NAND flash memory 24 and memory controller 25, with the result that the SSD 20 transitions from the normal mode to the standby mode indicative of a power-saving state. The limitation of the power supply indicates a state in which a power supply route from the power supply is shut off and a state in which power is not so sufficiently supplied that the functional units such as the DRAM 23, NAND flash memory 24 and memory controller 25 can operate normally.

When the standby mode transitions to the normal mode, the host 10 first sends an on request (normal mode transition request) to the power supply control circuit 26 of the SSD 20. In response to the on request, the power supply control circuit 26 sends an on power supply control request to the power supply circuit 22. In response to the on power supply control request, the power supply circuit 22 improves the supply of power to the DRAM 23, NAND flash memory 24 and memory controller 25, with the result that the SSD 20 transitions from the standby mode to the normal mode in which data can be transferred.

When the normal mode transitions to the standby mode, data (address management information) of the SRAM 25j in the memory controller 25 needs to be transferred to the NAND flash memory 24 in order to prevent data stored in a nonvolatile memory (e.g., the SRAM 25j) from being erased by shutting off power.

In this example, the SRAM 25j includes an area used as a storage area for address management information and an area not used as a storage area. Only the data of an area used as a storage area for address management information and data necessary for operations in the normal mode is transferred to the NAND flash memory 24. Hence, the data capacity transferred from the SRAM 25j to the NAND flash memory 24 can be lessened, and not only power consumption for data transfer can be decreased, but also time for transition between the standby mode and the normal mode can be shortened.

Even though address management information is stored in the DRAM 23 provided outside the memory controller 25, the same operation as in the case of the SRAM 24j can be performed.

FIG. 19 is a conceptual diagram showing an application example of a server including the SSD 20 according to each of the embodiments.

A server 400 is connected to the Internet 401. The server 400 includes an SSD 20. Furthermore, a terminal such as a computer 402 is connected to the Internet 401. A user gains access to the SSD 20 in the server 400 via the Internet 401. A plurality of servers, for example, 100 or more servers are placed in one location and, in this case, a large amount of power is consumed and a large amount of heat is generated. To prevent this, it is effective to use an SSD including the memory controller 25 of the present embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a NAND flash memory;
a first volatile memory which stores address management information for making a logical address assigned to a host and a physical address of the NAND flash memory correspondent with each other;
a controller which includes a second volatile memory and sends an operation request to the NAND flash memory and the first volatile memory to control the NAND flash memory and the first volatile memory; and
a power supply circuit electrically connected to the host through a power supply connector to receive power from the host through the power supply connector, the power supply circuit making power, which is supplied to part of the first volatile memory in accordance with a data capacity of the address management information stored in firmware in the controller in response to the operation request from the controller, to zero, and the power supply circuit making power, which is supplied to the second volatile memory, to zero.

2. A memory system comprising:
a nonvolatile memory;
a first volatile memory which stores address management information to make a logical address assigned to a host and a physical address of the nonvolatile memory correspondent with each other;
a controller which includes a second volatile memory and sends an operation request to the nonvolatile memory and the first volatile memory to control the nonvolatile memory and the first volatile memory; and
a power supply circuit which makes power supplied to part of the first volatile memory zero and makes power supplied to the second volatile memory zero in accordance with a data capacity of the address management information in response to the operation request from the controller.

3. A memory system comprising:
a nonvolatile memory;
a first volatile memory which stores management information to manage the nonvolatile memory;
a controller which controls operations of the nonvolatile memory and the first volatile memory; and
a power supply circuit which makes power supplied to part of the first volatile memory zero in accordance with a data capacity of the management information in response to a request from the controller.

4. The system of claim 3, wherein the controller includes a CPU, and the request from the controller is data stored in firmware that is operated by the CPU.

5. The system of claim 3, wherein the controller includes the first volatile memory, and the power supply circuit makes power supplied to a second area of the first volatile memory other than a first area thereof zero in response to a request of the controller, the first area storing the management information of the nonvolatile memory.

6. The system of claim 3, wherein the first volatile memory is an SRAM.

7. The system of claim 3, wherein the management information is address management information to make a logical address assigned to a host and a physical address of the nonvolatile memory correspondent with each other, and the first volatile memory has a storage capacity that is larger than the data capacity of the management information.

8. The system of claim 3, wherein the controller includes a second volatile memory, and the power supply circuit makes power supplied to the second volatile memory zero in response to a request from the controller.

9. The system of claim 8, wherein the first volatile memory is a DRAM, and the second volatile memory is an SRAM.

10. The system of claim 9, wherein the power supply circuit stops a periodical and automatic resupply of charges to part of the first volatile memory in response to a request from the controller.

11. The system of claim 8, wherein the first volatile memory has a storage capacity that is larger than a data capacity of the management information, and the second volatile memory has a storage capacity that is smaller than the data capacity of the management information.

12. The system of claim 3, wherein the first volatile memory includes a first storage area for storing data transferred between a host and the nonvolatile memory and a second storage area for storing the management information, and the power supply circuit makes power supplied to part of the second storage area zero.

13. The system of claim 3, wherein the nonvolatile memory is a NAND flash memory.

14. The system of claim 1, wherein the controller includes a CPU, and the request from the controller is data managed by firmware that is operated by the CPU.

15. The system of claim 1, wherein the first volatile memory is a DRAM, and the second volatile memory is an SRAM.

16. The system of claim 1, wherein the first volatile memory has a storage capacity that is larger than a data capacity of the management information, and the second volatile memory has a storage capacity that is smaller than the data capacity of the management information.

17. The system of claim 16, wherein the power supply circuit stops a periodical and automatic resupply of charges to part of the first volatile memory in response to a request from the controller.

18. The system of claim 1, wherein the first volatile memory includes a first storage area for storing data transferred between the host and the nonvolatile memory and a second storage area for storing the management information, and the power supply circuit makes power supplied to part of the second storage area zero.
